(19) United States
(12) Patent Application Publication
(10) Pub. No.: US 2016/0069457 A1
(43) Pub. Date: Mar. 10, 2016

(54) SLIDE RING SEAL

(71) Applicant: CARL FREUDENBERG KG, Weinheim (DE)

(72) Inventors: Soeren Neuberger, Hockenheim (DE); Klaus Lang, Eurasburg (DE)

(21) Appl. No.: 14/784,599

(22) PCT Filed: Jul. 10, 2013
(86) PCT No.: PCT/EP2013/002031

§ 371 Date: Oct. 15, 2015

(30) Foreign Application Priority Data
Apr. 22, 2013 (DE) 10 2013 006 839.8

(51) Int. Cl. F16J 15/34; F16J 15/36

(52) U.S. Cl. CPC F16J 15/3452; F16J 15/3496; F16J 15/36

(57) ABSTRACT

A slide ring seal has a slide ring, mounted in an axially movable manner, and a counterpart ring, wherein the slide ring and the counterpart ring each have sealing surfaces which bear against one another, wherein the sealing surface of the slide ring is situated opposite the sealing surface of the counterpart ring, and wherein the slide ring is pressed against the counterpart ring by a spring, wherein, with regard to refining and developing a slide ring seal of this type such that, while being inexpensive and easy to manufacture and having a construction involving a particularly small number of components, it seals off two chambers in a reliable and permanent manner, and the counterpart ring is formed in one piece with an axial projection which can be assigned to a shaft in order to fix the counterpart ring on the shaft.

### CROSS-REFERENCE TO RELATED APPLICATIONS

This application is a U.S. national stage application under 35 U.S.C. §371 of International Application No. PCT/EP2013/002031, filed on Jul. 10, 2013, and claims benefit to German Patent Application No. DE 10 2013 006 839.8, filed on Apr. 22, 2013. The International Application was published in English on Oct. 30, 2014, as WO 2014/173424 Al under PCT Article 21(2).

### FIELD

The invention relates to a slide ring seal.

### BACKGROUND

DE 10 2011 114 349 A1 has already disclosed a slide ring seal having a bellows-like spring means. In the case of the slide ring seal described above, the counterpart ring is accommodated in a supporting ring, wherein the supporting ring in turn is assigned to a shaft. The supporting ring is fixedly connected to the shaft so as to drive the counterpart ring along during a rotation of the shaft.

In the case of said configuration, it may be a problem that both the supporting ring and also the counterpart ring must be mounted on the shaft with a particularly high level of accuracy. As the supporting ring is being pressed onto the shaft, a required conicity, in particular of the counterpart ring, can be adversely affected. There is therefore a demand for slide ring seals in which a positional error of the counterpart ring virtually cannot occur. It is furthermore desirable for the slide ring seal to exhibit a high level of operational capability and to be robust.

### SUMMARY

An aspect of the invention provides a slide ring seal, comprising: a slide ring, which is mounted in an axially movable manner; and a counterpart ring, wherein the slide ring and the counterpart ring each include a first sealing surface and a second sealing surface which bear against one another, wherein the first sealing surface; a sealing surface of the slide ring, is situated opposite the second sealing surface, a sealing surface of the counterpart ring, and wherein the slide ring is pressed against the counterpart ring using a spring, and wherein the counterpart ring is formed in one piece with an axial projection which can be assigned to a shaft so as to fix the counterpart ring on the shaft.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a sectional view of the upper part of a slide ring seal, in which the counterpart ring and a projection projecting therefrom in an axial direction are formed in one piece; and

FIG. 2 is a partial sectional view of a projection formed in one piece with a counterpart ring, which projection is fastened to a shaft with an interference fit, in such a way that an encircling gap is formed.

### DETAILED DESCRIPTION

An aspect of the invention refines and develops a slide ring seal of the type specified in the introduction such that, while being inexpensive and easy to manufacture and having a construction involving a particularly small number of components, it seals off two chambers in a reliable and permanent manner.

According to an aspect of the invention, it has firstly been identified that a separate supporting ring can be dispensed with. By contrast to the prior art, the counterpart ring is specifically not accommodated in a supporting ring which must be manufactured as a separate part. Rather, the counterpart ring has an axial projection which can be assigned to a shaft in order to fix the counterpart ring on the shaft. It is provided according to the invention that the projection and the counterpart ring are formed in one piece, and preferably in a materially integral manner. In this respect, the supporting ring which is conventionally used in the prior art is integrated into the counterpart ring. This yields a significant simplification of the construction of the slide ring seal. In particular, an initially required conicity can be set already during the manufacture of the counterpart ring and of the projection thereof at the factory. According to the invention, a separate supporting ring for the counterpart ring is omitted, such that the slide ring seal according to the invention has a construction which involves few components and which is robust.

The projection could be in the form of a cylindrical sleeve. A cylindrical sleeve can encircle a shaft. The cylindrical sleeve may be pushed in the manner of a ring over a shaft and be fixed thereto by means of an interference fit.

The spring means could be of bellows-like configuration. By means of this specific configuration, the spring means can absorb torque inputs and have a compensating action such that the sealing surfaces of the slide ring and of the counterpart ring are permanently oriented relative to one another in an operationally capable manner.

The spring means could be manufactured from a polymer. Polymers are inexpensive. Surprisingly, polymers or plastics are stable enough to satisfy the mechanical requirements placed on a spring means.

Against this background, the spring means could be manufactured from an elastomer. In particular, it is conceivable for the elastomer to be manufactured from, or have, a natural rubber. A spring means composed of an elastomer can absorb torsional deformations in a particularly effective manner and compensate these such that the sealing surfaces of the slide ring and of the counterpart ring are suitably oriented relative to one another.

The bellows-like spring means could bear by way of an annular stop region against the slide ring and be fixed by way of an annular connection region to a housing, wherein the stop region and the connection region are connected to one another by at least one elastically deformable hinge region. By means of this specific refinement, the spring means has imparted to it a geometric shape which, while being deflectable to a small extent in the axial direction, makes it possible for the required radial and torsional stiffness to be ensured. It is nevertheless possible, by means of the hinge region and a suitable selection of the stiffness of the elastomer, for an adequate contact-pressure force to be exerted on the slide ring.

Against this background, the hinge region could be of S-shaped form in cross section. In this way, while a small amount of deflection is permitted in an axial direction, the required radial and torsional stiffness is ensured.

At least one sealing surface could have elevations or unevennesses of a size of 0.1 μm to W, wherein W is calculated in accordance with formula

W=0.03Dm/s,

wherein the mean diameter Dm represents the mean value of outer diameter and inner diameter of the circular-ring-shaped sealing surface and wherein s represents the thickness of the slide ring or counterpart ring. It has surprisingly been identified that manufacturing-induced unevennesses on the slide ring and/or on the counterpart ring can be compensated by the bellows-like spring means. Cumbersome rectification and reworking of sealing surfaces of counterpart rings and slide rings is thus not necessary. An elevation, unevenness or evenness within the context of this description is measured in accordance with DIN ISO 1101. The above-specified factor of 0.03 may also assume a higher value that a person skilled in the art may find suitable on the basis of this description.

At least one sealing surface could have elevations or unevennesses of a size of 0.1 μm to 500 μm. The slide ring and/or the counterpart ring could have a thickness of at most 5 mm. It has surprisingly been identified that a slide ring seal in which the counterpart rings and slide rings are very thin, specifically are of virtually foil-like form, exhibit particularly high operational capability. Particularly thin slide rings and counterpart rings can be oriented relative to one another in an ideal manner by the spring force of a bellows-like spring means. In this way, during operation, a gap shape is generated which is dependent only to a very small extent on manufacturing tolerances of the sealing surfaces and which always adapts and aligns in an ideal manner. The gap shape may be of slightly divergent, parallel or else convergent cross section.

The projection could encircle the shaft. In this way, the projection can be pressed onto the shaft with an interference fit.

Against this background, the projection could be seated on the shaft with an interference fit. The counterpart ring can be mounted on a shaft without problems by means of an interference fit.

The projection could have a portion which faces toward the sealing surface of the counterpart ring, which portion encircles the shaft so as to form an encircling gap. The introduction of the projection onto the shaft is facilitated in this way. By means of a suitable configuration of the projection, the latter is also tolerant and robust with respect to diameter fluctuations of the shaft. The projection could run conically in regions and be designed so as to provide a region which does not bear against the shaft and which thus does not transmit to the counterpart ring the deformations induced by the interference fit. This leads to a small positional error of the counterpart ring during assembly, and renders the slide ring seal as a whole highly robust.

As a result of the formation of the encircling gap, decoupling of the counterpart ring from plastic deformations in the sheet metal of the projection is realized. Since, as a result of the decoupling, very large overlaps and plastic deformations are permissible in the sheet metal, the sealing seat thereof may be of metallic configuration without additional sealing aids. A metallic seal or sealing action can be realized. The plastic deformation reliably closes off leakage channels. The projection could be sealed off statically with respect to the shaft. The static seal may be fully rubberized, partially rubberized, provided with sealing lacquer or of metallically sealing configuration.

The encircling gap could be in the form of a conical gap. Stresses and deformations of the projection can thus be reduced. Pressing-in of the projection can be realized in an effective manner.

It is preferable if one third of the projection does not bear against the shaft. A deformation of the counterpart ring is thereby decoupled from any tolerances introduced by the interference fit. The counterpart ring and the projection formed in one piece therewith are preferably of L-shaped form in cross section at least in regions. This permits simple manufacturing. Moreover, very thin wall thicknesses can be realized. In this way, flexibility of the counterpart ring is attained which renders the latter insensitive with respect to manufacturing tolerances of the sealing surfaces. The counterpart ring together with projection is so robust in the uninstalled state that manufacturing-induced and force-induced deformations, in particular a conicity, are not adversely affected during assembly.

Said slide ring seal is preferably in the form of a gas-lubricated slide ring seal with hydrodynamic lift channels in the sealing surfaces.

The slide ring seal described here may be used for gearbox seals with high sliding speeds and moderate pressures. It is in particular conceivable for the slide ring seal to be used in the automotive industry. Here, specifically, it is conceivable for the slide ring seal to be used as a turbocharger seal, crankshaft seal, gearbox seal or electric motor seal.

Further uses for the slide ring seal described here are conceivable.

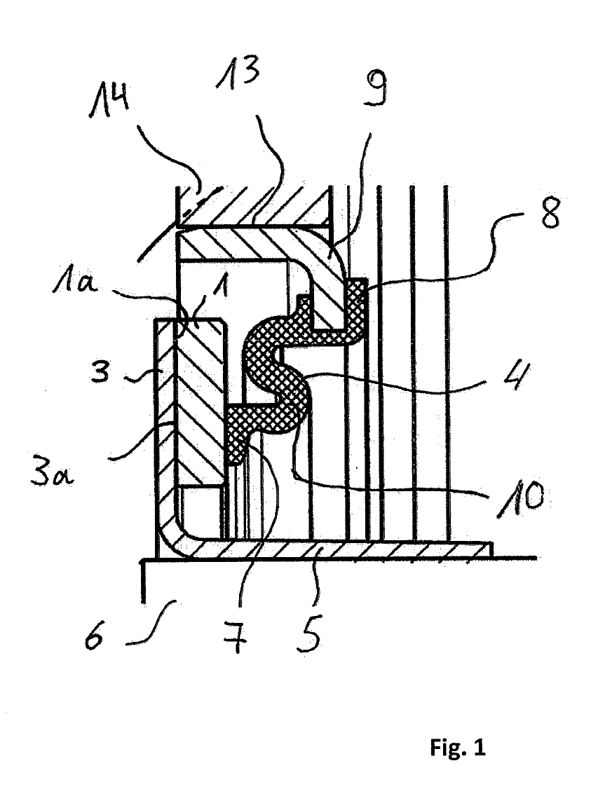

FIG. 1 shows a slide ring seal, comprising a slide ring 1, which is mounted in an axially movable manner, and a counterpart ring 3, wherein the slide ring 1 and the counterpart ring 3 each have sealing surfaces 1a, 3a which bear against one another, wherein the sealing surface 1a of the slide ring 1 is situated opposite the sealing surface 3a of the counterpart ring 3, and wherein the slide ring 1 is pressed against the counterpart ring 3 by a spring means 4.

The counterpart ring 3 is formed in one piece with an axial projection 5 which can be assigned to a shaft 6 in order to fix the counterpart ring 3 on the shaft 6.

The projection 5 is in the form of a cylindrical sleeve. The projection 5 is formed in one piece with the counterpart ring 3 in a materially integral manner. The counterpart ring 3 and the projection 5 form a single separate component which is of L-shaped form in cross section in regions, specifically on one side of the axis of rotation. The component is manufactured preferably from sheet metal.

The spring means 4 is of bellows-like form. The spring means 4 is manufactured from an elastomer. The bellows-like spring means 4 bears by way of an annular stop region 7 against the slide ring 1 and is fixed by way of an annular connection region 8 to a housing 9, wherein the stop region 7 and the connection region 8 are connected to one another by at least one elastically deformable hinge region 10. The stop region 7, the connection region 8 and the hinge region 10 are formed in one piece in a materially integral manner. A natural rubber is preferably used for the manufacture of the bellows-like spring means 4.

At least one sealing surface 1a and/or 3a has elevations or unevennesses of a size of 0.1 μm to 500 μm. The slide ring 1 and/or the counterpart ring 3 have/has a thickness of at most 5 mm. In this way, the slide ring 1 and the counterpart ring 3 exhibit a particularly high level of flexibility. The slide ring 1 and the counterpart ring 3 are manufactured preferably from sheet metal.

FIG. 1 shows a slide ring seal in which a region 13 of the housing is applied to a counterpart wall 14 in a metallically sealing, fully rubberized or partially rubberized manner or with the interposition of a sealing compound, in particular a sealing lacquer.

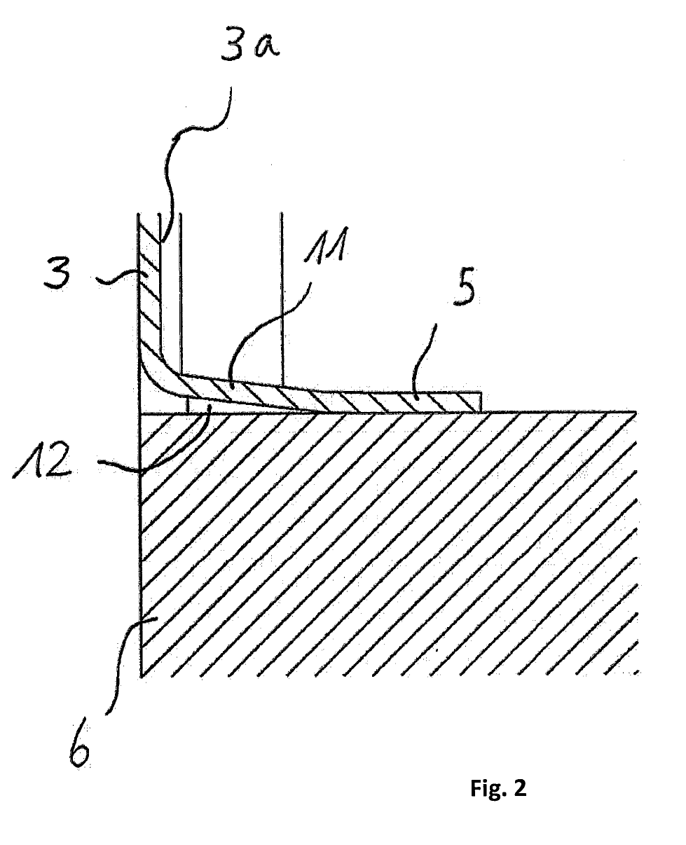

FIG. 2 shows an arrangement comprising a shaft 6 and, in sections, a slide ring seal of the type described here, wherein the projection 5 encircles the shaft 6. The projection 5 is seated on the shaft 6 with an interference fit and connected in a rotationally conjoint manner thereto. The projection 5 has a portion 11 which faces the sealing surface 3a of the counterpart ring 3, which portion encircles the shaft 6 so as to form an encircling gap 12. Specifically, the final third of the projection 5 is of conical form such that, after the projection 5 is pressed onto the shaft 6, said final third does not bear against said shaft. In this way, the counterpart ring 3 is decoupled from deformations and stresses which can be introduced by the interference fit. The gap 12 is formed so as to taper to a point on the side facing toward the slide ring 1. In this way, a conical gap is formed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1: A slide ring seal, comprising:
a slide ring, which is mounted in an axially movable manner; and
a counterpart ring,
wherein the slide ring has a first sealing surface and the counterpart ring has a second sealing surface bearing against the first sealing surface,
wherein the first sealing surface is situated opposite the second sealing surface, and
wherein the slide ring is pressed against the counterpart ring using a spring, and
wherein the counterpart ring is formed in one piece with an axial projection contacting the outer circumference of a shaft so as to fix the counterpart ring on the shaft.

2: The seal of claim 1, wherein the projection is in the form of a cylindrical sleeve.

3: The seal of claim 1, wherein the spring is configured as a bellows.

4: The seal of claim 3, wherein the spring includes a polymer.

5: The seal of claim 4, wherein the polymer is an elastomer.

6: The seal of claim 1, comprising a bellows-like spring, which bears against the slide ring by way of an annular stop region, and
wherein the bellows-like spring is fixed by way of an annular connection region to a housing, and
wherein the stop region and the connection region are connected to one another by at least one elastically deformable hinge region.

7: The seal of claim 6, wherein the hinge region is of S-shaped form in cross section.

8: The seal of claim 1, wherein at least one sealing surface includes elevations or unevennesses of a size of 0.1 μm to W,
wherein W is calculated in accordance with formula
W=0.03Dm/s,
wherein a mean diameter, Dm, represents a mean value of outer diameter and inner diameter of a circular-ring-shaped sealing surface, and
wherein s represents a thickness of the slide ring or counterpart ring.

9: An arrangement, comprising:
a shaft; and
the slide ring seal of claim 1,
wherein the axial projection encircles the shaft.

10: The arrangement of claim 9, wherein the projection (5) is seated on the shaft (6) with an interference fit.

11: The arrangement of claim 9, wherein the axial projection includes a portion which faces toward the sealing surface of the counterpart ring,
wherein the portion encircles the shaft so as to form an encircling gap.

12: The arrangement of claim 11, wherein the gap is in the form of a conical gap.
